(19) United States
(12) Patent Application Publication
(10) Pub. No.: US 2025/0303442 A1
(43) Pub. Date: Oct. 2, 2025

(54) METHOD FOR PRODUCING MULTILAYER COATING FILM, AND MULTILAYER COATING FILM

(71) Applicants: KANSAI PAINT CO., LTD., Hyogo (JP); MAZDA MOTOR CORPORATION, Hiroshima (JP)

(72) Inventors: Yosuke HASEGAWA, Fukuoka (JP); Satoru FURUMURA, Fukuoka (JP); Takakazu YAMANE, Aki-gun, Hiroshima (JP); Keiichi OKAMOTO, Aki-gun, Hiroshima (JP); Kouji TERAMOTO, Aki-gun, Hiroshima (JP); Ryuji NONAKA, Aki-gun, Hiroshima (JP)

(73) Assignees: KANSAI PAINT CO., LTD., Hyogo (JP); MAZDA MOTOR CORPORATION, Hiroshima (JP)

(21) Appl. No.: 18/864,260

(22) PCT Filed: May 10, 2023
(86) PCT No.: PCT/JP2023/017645

§ 371 Date: Nov. 8, 2024

(30) Foreign Application Priority Data
May 13, 2022 (JP) 2022-079518

(51) Int. Cl. B05D 5/06; B05D 7/00; B05D 7/04

(52) U.S. Cl. CPC B05D 5/068; B05D 7/04; B05D 7/572; B05D 7/577; B05D 2202/15; B05D 2301/00; B05D 2401/20; B05D 2430/00; B05D 2502/00; B05D 2503/00; B05D 2508/00

(57) ABSTRACT

The present invention relates to a method for producing a multilayer coating film, the method including sequentially applying a base coating, a glitter pigment dispersion, and a two-component clear coating on or above an electrodeposition coating film and then simultaneously curing these three coating films, in which the glitter pigment dispersion includes an aluminum flake pigment, titanium oxide, a hydroxy group-containing acrylic resin, a viscosity modifier, and water, a content of the titanium oxide is 10 mass % to 20 mass % of a total solid content of the glitter pigment dispersion, and a mass ratio of the aluminum flake pigment/the titanium oxide is 0.8 to 1.2.

### TECHNICAL FIELD

The present invention relates to a method for producing a multilayer coating film, and a multilayer coating film.

### BACKGROUND ART

The purpose of applying a coating is mainly to protect materials and impart an excellent appearance. For industrial products, excellent appearance, particularly “texture”, is important in terms of enhancing product power of the industrial products. Although there are various textures for industrial products desired by consumers, luster as metal has (hereinafter, referred to as “metallic luster”) has recently been desired in the field of automobile exterior panels, automobile components, home electronics, and the like.

The metallic luster represents a texture that a surface has no graininess, like a mirror surface, and a coated plate looks shiny when viewed nearly perpendicular to the coated plate (highlight). In such a texture, a white metallic texture has been in demand in which a highlight region has a high lightness while a (shade) region where a coating film is obliquely viewed has a lower lightness than that of the highlight region but has a perceivable white color.

As a method for forming a laminated coating film, the method achieving a metallic appearance of a metal-plated surface or the like without a plating treatment, Patent Literature 1 describes a method for producing a laminated coating film exhibiting a metallic appearance, the method including: applying, to an object to be coated, a metallic coating containing an opaque scale-like pigment and a glitter pigment obtained by crushing a vapor-deposited metal film into metal pieces, and applying a clear top coating to the formed metallic coating film layer.

As a method for producing a glitter coating film, the method being capable of obtaining a coating film that can achieve clear whiteness and has no darkened color when the coating film is obliquely viewed (at shade portion) while avoiding a reduction in brightness of an aluminum flake pigment, Patent Literature 2 describes a method for producing a glitter coating film, the method including: forming, on a substrate, a glitter base coating film containing an aluminum flake pigment having a specific shape, and then forming a first clear coating film containing organic resin fine particles on the glitter base coating film, and further forming a second clear coating film on the first clear coating film.

As a method for producing a coating film, the method being capable of forming a coating film that has a high whiteness, a delicate appearance, and a small and calm lightness change from a highlight (in the vicinity of specularly reflected light) to a shade (in an oblique direction), Patent Literature 3 describes a method for producing a coating film, the method including: sequentially forming a color base coating film having a lightness L* in a L*a*b* color system within a range of 75 to 90, a metallic base coating film containing four types of optical interference pigments having different interference colors from each other in a highlight, and a top clear coating film.

As a method for producing a multilayer coating film that exhibits a high lightness throughout the film from a highlight to a shade, particularly is capable of imparting a white metallic luster, and is excellent in adhesion and water resistance, Patent Literature 4 describes a method for producing a multilayer coating film, the method including the following steps (1) to (4): a step (1) of applying a base coating (X) to an object to be coated to form a base coating film; a step (2) of applying a glitter pigment dispersion (Y) to the base coating film formed in the step (1) to form a glitter coating film having a dry film thickness of 0.01 μm to 5 μm; a step (3) of applying a clear coating (Z) to the glitter coating film formed in the step (2) to form a clear coating film; and a step (4) of heating the uncured base coating film, the uncured glitter coating film, and the uncured clear coating film formed in steps (1) to (3), respectively, to simultaneously cure these three coating films, in which the glitter pigment dispersion (Y) contains an aluminum flake pigment (A), light-scattering particles (B), a hydroxy group-containing acrylic resin (C), and water.

### CITATION LIST

### Patent Literature

Patent Literature 1: JP2004-8931A
Patent Literature 2: JP2003-245603A
Patent Literature 3: JP2011-45805A
Patent Literature 4: WO2019/065961

### SUMMARY OF INVENTION

### Technical Problem

In the technique described in Patent Literature 1, concentrations of the scale-like pigment and the glitter pigment are increased in the metallic coating, so that the scale-like pigment and the glitter pigment are oriented in parallel to a coating film surface to thus form a metallic coating film, but the lightness greatly changes from the highlight to the shade, and the shade becomes black, making it impossible to obtain a white metallic coating film.

According to the method described in Patent Literature 2, lamination of the coating film containing the organic resin fine particles on the glitter coating film containing the aluminum flake pigment makes it possible to obtain a glitter coating film that achieves clear whiteness and has no darkened color when the coating film is obliquely viewed (at shade portion), but incident light scatters due to the organic resin fine particles, and the brightness of the glitter coating film is deteriorated.

According to the method described in Patent Literature 3, the presence of the plurality of types of optical interference pigments having different interference colors from each other makes it possible to obtain a delicate white pearl coating color, but the use of optical interference flakes results in insufficient brightness in the highlight and a great lightness change from the highlight to the shade, making it impossible to obtain the white metallic coating film described above.

The multilayer coating film formed by the method described in Patent Literature 4 has an excellent “texture”, but during coating, during transfer to a next step, during heat curing of the coating film, and the like, dirt may adhere to surfaces of the coating film surfaces or dents may occur in the coating films, which may reduce an appearance design, and thus excellent reworkability is also required.

An object of the present invention is to provide a white metallic multilayer coating film having a high gloss at a highlight, a high lightness throughout the film from the highlight to a shade, and an excellent reworkability, and a method for producing the same.

### Solution to Problem

The present invention includes subject matters described in the following items.

Item 1. A method for producing a multilayer coating film, the method including the following steps (1) to (4):
a step (1) of applying a base coating (X) directly on an electrodeposition coating film to form a base coating film having a dry film thickness of 20 μm to 35 μm and a lightness L*45 of 85 to 95;
a step (2) of applying a glitter pigment dispersion (Y) on or above the base coating film formed in the step (1) to form a glitter coating film having a dry film thickness of 0.01 μm to 1.0 μm;
a step (3) of applying a two-component clear coating (Z) including a hydroxy group-containing acrylic resin and a polyisocyanate compound on or above the glitter coating film formed in the step (2) to form a clear coating film; and
a step (4) of heating the uncured base coating film, the uncured glitter coating film, and the uncured clear coating film formed in the steps (1) to (3), respectively, to simultaneously cure these three coating films, in which
the glitter pigment dispersion (Y) includes an aluminum flake pigment (A), titanium oxide (B), a hydroxy group-containing acrylic resin (C), a viscosity modifier (D), and water,
a content of the titanium oxide (B) is 10 mass % to 20 mass % of a total solid content of the glitter pigment dispersion (Y),
a blending ratio of the aluminum flake pigment (A) to the titanium oxide (B) is 0.8 to 1.2 in terms of a mass ratio of the aluminum flake pigment (A)/the titanium oxide (B), and
in the multilayer coating film, a lightness L*45 is within a range of 75 to 85, a 60-degree specular gloss is within a range of 95 to 105, and a flip-flop value is within a range of 0.5 to 0.7.

Item 2. A multilayer coating film including:
an electrodeposition coating film;
a base coating film;
a glitter coating film; and
a clear coating film in this order, in which
the base coating film has a film thickness of 20 μm to 35 μm and a lightness L*45 of 85 to 95,
the glitter coating film includes an aluminum flake pigment (A) and titanium oxide (B), and has a film thickness of 0.01 μm to 1.0 μm,
a content of the titanium oxide (B) in the glitter coating film is 10 mass % to 20 mass %, and a mass ratio of the aluminum flake pigment (A)/the titanium oxide (B) is 0.8 to 1.2,
the clear coating film includes a cured product of a hydroxy group-containing acrylic resin and a polyisocyanate compound, and
in the multilayer coating film, a lightness L*45 is within a range of 75 to 85, a 60-degree specular gloss is within a range of 95 to 105, and a flip-flop value is within a range of 0.5 to 0.7.

### Advantageous Effects of Invention

According to the present invention, a white metallic multilayer coating film having a high gloss at a highlight, a high lightness throughout the film from the highlight to a shade, and an excellent reworkability, and a method for producing the same can be provided.

### DESCRIPTION OF EMBODIMENTS

### <Method for Producing Multilayer Coating Film>

A method for producing a multilayer coating film of the present invention includes the following steps (1) to (4):
a step (1) of applying a base coating (X) directly on an electrodeposition coating film to form a base coating film having a dry film thickness of 20 μm to 35 μm and a lightness L*45 of 85 to 95;
a step (2) of applying a glitter pigment dispersion (Y) on or above the base coating film formed in the step (1) to form a glitter coating film having a dry film thickness of 0.01 μm to 1.0 μm;
a step (3) of applying a two-component clear coating (Z) including a hydroxy group-containing acrylic resin and a polyisocyanate compound on or above the glitter coating film formed in the step (2) to form a clear coating film; and
a step (4) of heating the uncured base coating film, the uncured glitter coating film, and the uncured clear coating film formed in the steps (1) to (3), respectively, to simultaneously cure these three coating films, in which
the glitter pigment dispersion (Y) includes an aluminum flake pigment (A), titanium oxide (B), a hydroxy group-containing acrylic resin (C), a viscosity modifier (D), and water,
a content of the titanium oxide (B) is 10 mass % to 20 mass % of a total solid content of the glitter pigment dispersion (Y),
a blending ratio of the aluminum flake pigment (A) to the titanium oxide (B) is 0.8 to 1.2 in terms of a mass ratio of the aluminum flake pigment (A)/the titanium oxide (B), and
in the multilayer coating film, a lightness L*45 is within a range of 75 to 85, a 60-degree specular gloss is within a range of 95 to 105, and a flip-flop value is within a range of 0.5 to 0.7.

### [Step (1)]

In the present invention, the step (1) is a step of applying a base coating (X) directly on an electrodeposition coating film to form a base coating film having a dry film thickness of 20 μm to 35 μm and a lightness L*45 of 85 to 95.

### Electrodeposition Coating Film

According to the method for producing a multilayer coating film of the present invention, the electrodeposition coating is first applied on or above an object to be coated such as a steel plate, followed by heating and curing to form the electrodeposition coating film.

As the above steel sheet, a steel sheet for an automobile body, such as a galvannealed steel sheet, a galvanized steel sheet, an electrogalvanized steel sheet, and a cold-rolled steel sheet can be used. A surface of the steel sheet may be subjected to a surface treatment such as a phosphate treatment, a chromate treatment, and a composite oxide treatment.

As the above electrodeposition coating, a well-known electrodeposition coating can be used, for example, one described in JP2003-306796A can be used, and in particular, a cationic electrodeposition coating can be suitably used.

### Base Coating (X)

The base coating film can be formed by applying the base coating (X) to the above electrodeposition coating film.

The base coating film has a dry film thickness of 20 μm to 35 μm, and preferably 23 μm to 31 μm, in terms of substrate-masking properties, finish, and the like.

The lightness L*45 of the base coating film is 85 to 95, and preferably 87 to 92 in terms of forming a white metallic multilayer coating film having a high gloss at a highlight and a high lightness throughout the film from the highlight to a shade.

Here, the lightness L*45 specifically refers to a lightness L* in a L*a*b* color system calculated based on a spectral reflectance of a light that is illuminated at an angle of 45 degrees with respect to the coating film and received at an angle of 45 degrees with respect to a specularly reflected light. Specifically, the lightness L*45 can be defined as a value measured using a multi-angle spectrophotometer “MA-68II” (trade name, manufactured by Videojet X-Rite K.K.).

As the base coating (X), a well-known thermosetting coating containing a vehicle-forming resin, a pigment, and a solvent, such as an organic solvent and/or water, as main components can be specifically used.

Examples of the vehicle-forming resin used in the base coating (X) include a thermosetting resin and a room-temperature-curable resin. In terms of water resistance, chemical resistance, weather resistance, and the like, the thermosetting resin is desired. It is preferable to use a combination of a base resin and a crosslinking agent as the vehicle-forming resin.

The base resin is preferably a resin that has an excellent weather resistance, transparency, and the like. Specific examples thereof include an acrylic resin, a polyester resin, an epoxy resin, and a urethane resin.

Examples of the above acrylic resin include resins obtained by copolymerizing α,β-ethylenically unsaturated carboxylic acids, (meth)acrylic acid esters having a functional group, such as a hydroxy group, an amide group, or a methylol group, other (meth)acrylic acid esters, styrene, and the like.

The polyester resin may use, for example, a polyester resin obtained by a condensation reaction of a polyhydric alcohol, such as ethylene glycol, propylene glycol, butylene glycol, 1,6-hexanediol, trimethylolpropane, and pentaerythritol, with a polyvalent carboxylic acid component, such as adipic acid, isophthalic acid, terephthalic acid, phthalic anhydride, hexahydrophthalic anhydride, and trimellitic anhydride.

Examples of the epoxy resin include an epoxy ester resin obtained by a method of synthesizing an epoxy ester by a reaction of an epoxy group and an unsaturated fatty acid, and adding an α,β-unsaturated acid to this unsaturated group, or by a method of esterifying a hydroxy group of an epoxy ester and a polybasic acid, such as phthalic acid or trimellitic acid.

Examples of the urethane resin include a urethane resin whose molecular weight is increased by reacting the above acrylic resin, the above polyester resin, or the above epoxy resin with a diisocyanate compound.

The base coating (X) may be an aqueous coating or a solvent coating. In terms of reducing VOC of the coating, the base coating (X) is preferably an aqueous coating. When the base coating (X) is an aqueous coating, the above base resin can be made soluble in water or dispersible in water by using a resin containing a hydrophilic group, such as a carboxyl group, a hydroxy group, a methylol group, an amino group, a sulfonic acid group, or a polyoxyethylene bond, most generally a carboxyl group, in an amount sufficient for making the resin soluble in water or dispersible in water, and neutralizing the hydrophilic group to form an alkali salt. The amount of the hydrophilic group, for example, a carboxyl group used in this case is not particularly limited, and can be freely selected depending on the degree of water solubilization or water dispersion. The amount of the hydrophilic group can be generally about 10 mgKOH/g or more, and preferably 30 mgKOH/g to 200 mgKOH/g based on an acid value is. Examples of the alkaline substance used in neutralization include sodium hydroxide and an amine compound.

Moreover, the water dispersion of the above resin can be performed by subjecting the above monomer components to emulsion polymerization in the presence of a surfactant and a water-soluble resin. Furthermore, the water dispersion can also be obtained by, for example, dispersing the above resin in water in the presence of an emulsifier. In the water dispersion, the base resin may not contain the above hydrophilic group by any means, or may contain the above hydrophilic group in an amount less than that of the water-soluble resin.

The crosslinking agent is used to crosslink and cure the above base resin by heating. Examples of the crosslinking agent include an amino resin, a polyisocyanate compound, a blocked polyisocyanate compound, an epoxy group-containing compound, a carboxyl group-containing compound, a carbodiimide group-containing compound, a hydrazide group-containing compound, and a semicarbazide group-containing compound. Among these, the amino resin reactive with a hydroxy group, the polyisocyanate compound, the blocked polyisocyanate compound, and the carbodiimide group-containing compound reactive with a carboxyl group are preferable. The above crosslinking agents may be used alone or in combination of two or more thereof.

Specifically, an amino resin obtained by condensation or co-condensation of formaldehyde with melamine, benzoguanamine, urea, or the like, or further etherification with a lower monohydric alcohol is suitably used. A polyisocyanate compound or a blocked polyisocyanate compound can also be suitably used.

A ratio of each component in the base coating (X) may be freely selected as required. In terms of water resistance, finish, and the like, it is generally preferable that the content of the base resin be 60 mass % to 90 mass %, and particularly 70 mass % to 85 mass %, and the content of the crosslinking agent be 10 mass % to 40 mass %, and particularly 15 mass % to 30 mass %, based on a total mass of the both components of the base resin and the crosslinking agent.

The pigment provides color and substrate-masking properties to the base coating film formed by the base coating (X). By adjusting a type and a blending amount of the pigment, a lightness L*45 value of the coating film obtained by the base coating (X) can be adjusted. Examples of the pigment include a metallic pigment, a rust preventive pigment, a colorant pigment, and an extender pigment. Among these, the colorant pigment is preferably used, and a titanium oxide pigment is more preferably used in terms of imparting a white metallic texture to the multilayer coating film.

In the base coating (X) of the present invention, a colorant pigment other than the titanium oxide pigment can be used in an appropriate combination depending on substrate-masking properties, desired color, and the like.

A blending amount of the pigment in the base coating (X) is preferably 50 parts by mass to 200 parts by mass, and more preferably 80 parts by mass to 150 parts by mass, based on 100 parts by mass of a total amount of the base resin and the crosslinking agent.

The base coating (X) can be applied by a general method. When the base coating (X) is an aqueous coating, for example, deionized water and optionally additives, such as a thickener and an antifoaming agent, are added to the base coating (X), so that a solid content is adjusted to about 30 mass % to 70 mass % and a viscosity is adjusted to 500 cps/6 rpm to 6000 cps/6 rpm (B-type viscometer), and then, the resultant can be applied to a surface of an object to be coated by spray coating, rotary atomization coating, or the like. An electrostatic charge may be applied, if necessary, during coating.

### [Step (2)]

In the present invention, the step (2) is a step of applying a glitter pigment dispersion (Y) on or above the base coating film formed in the step (1) to form aglitter coating film having a dry film thickness of 0.01 μm to 1.0 μm.

### Glitter Pigment Dispersion (Y)

The glitter coating film can be formed by applying the glitter pigment dispersion (Y) on or above the above base coating film.

The glitter coating film has the dry film thickness of 0.01 μm to 1.0 μm, and preferably 0.1 μm to 0.8 μm, in terms of forming a white metallic multilayer coating film having a high gloss at a highlight, a high lightness throughout the film from the highlight to a shade, and an excellent reworkability.

The glitter pigment dispersion (Y) contains an aluminum flake pigment (A), titanium oxide (B), a hydroxy group-containing acrylic resin (C), a viscosity modifier (D), and water.

### Aluminum Flake Pigment (A)

The aluminum flake pigment (A) is generally produced by grinding or milling aluminum in a ball mill or an attritor mill in the presence of a grinding liquid medium using a grinding aid. In addition to a higher fatty acid, such as oleic acid, stearic acid, isostearic acid, lauric acid, palmitic acid, and myristic acid, aliphatic amine, aliphatic amide, and aliphatic alcohol can be used as the grinding aid used in the step of producing the aluminum flake pigment (A). An aliphatic hydrocarbon, such as mineral spirit, is used as the grinding liquid medium.

The aluminum flake pigment (A) preferably has an average particle size in a range of 1 μm to 100 μm, and more preferably in a range of 5 μm to 50 μm, and particularly preferably in a range of 7 μm to 30 μm. A thickness of the aluminum flake pigment (A) is preferably in a range of 0.01 μm to 2.0 μm, and particularly preferably in a range of 0.02 μm to 1.0 μm.

A content of the aluminum flake pigment (A) in the glitter pigment dispersion (Y) is preferably 1 mass % to 30 mass %, and more preferably 5 mass % to 20 mass % of a total solid content of the glitter pigment dispersion (Y), in terms of forming a white metallic multilayer coating film having a high gloss at a highlight, a high lightness throughout the film from the highlight to a shade, and an excellent reworkability.

### Titanium Oxide (B)

A content of the titanium oxide (B) in the glitter pigment dispersion (Y) is 10 mass % to 20 mass %, and preferably 12 mass % to 18 mass % of the total solid content of the glitter pigment dispersion (Y).

When the content of the titanium oxide (B) is within the above range, a white metallic multilayer coating film having a high gloss at a highlight, a high lightness throughout the film from the highlight to a shade, and an excellent reworkability can be formed.

A blending ratio of the aluminum flake pigment (A) to the titanium oxide (B) in the glitter pigment dispersion (Y) is 0.8 to 1.2, preferably 0.85 to 1.15, in terms of a mass ratio of the aluminum flake pigment (A)/the titanium oxide (B).

When the blending ratio of the aluminum flake pigment (A) to the titanium oxide (B) is in the above range, a white metallic multilayer coating film having a high gloss at a highlight, a high lightness throughout the film from the highlight to a shade, and an excellent reworkability can be formed.

### Hydroxy Group-Containing Acrylic Resin (C)

The hydroxy group-containing acrylic resin (C) is an acrylic resin having at least one hydroxy group in one molecule. The hydroxy group-containing acrylic resin (C) can be a well-known water-soluble or water-dispersible hydroxy group-containing acrylic resin that has been used in the aqueous coating in the related art. The hydroxy group-containing acrylic resin (C) can be produced by copolymerizing, for example, a hydroxy group-containing polymerizable unsaturated monomer with other polymerizable unsaturated monomers that are copolymerizable with the hydroxy group-containing polymerizable unsaturated monomer by using a well-known method, such as a solution polymerization method.

The above hydroxy group-containing polymerizable unsaturated monomer has at least one hydroxy group and at least one polymerizable unsaturated bond in one molecule. Examples thereof include a monoesterified product of glycols and acrylic acid or methacrylic acid, such as hydroxyethyl (meth)acrylate, hydroxpropyl (meth)acrylate, hydroxybutyl (meth)acrylate, and polyethylene glycol mono(meth)acrylate; and a compound obtained by ring-opening polymerization of ε-caprolactone with the above monoesterified product of the polyhydric alcohols and acrylic acid or methacrylic acid.

The other polymerizable unsaturated monomers that are copolymerizable with the hydroxy group-containing polymerizable unsaturated monomer can be appropriately selected and used depending on the properties desired for the hydroxy group-containing acrylic resin. Specific examples of such monomers are listed below. These polymerizable unsaturated monomers may be used alone or in combination of two or more thereof.

In the present specification, the term “(meth)acrylate” means acrylate or methacrylate. The term “(meth)acrylic acid” means acrylic acid or methacrylic acid. The term “(meth)acryloyl” means acryloyl or methacryloyl. The term “(meth)acrylamide” means acrylamide or methacrylamide.
(i) Alkyl or cycloalkyl (meth)acrylate, such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, n-octyl (meth)acrylate, 2-ethylhexyl (meth)acrylate, nonyl (meth)acrylate, tridecyl (meth)acrylate, lauryl (meth)acrylate, stearyl (meth)acrylate, isostearyl (meth)acrylate, cyclohexyl (meth)acrylate, methylcyclohexyl (meth)acrylate, t-butylcyclohexyl (meth)acrylate, cyclododecyl (meth)acrylate, and tricyclodecanyl (meth)acrylate.
(ii) Isobornyl group-containing polymerizable unsaturated monomer, such as isobornyl (meth)acrylate.
(iii) Adamantyl group-containing polymerizable unsaturated monomers, such as adamantyl (meth)acrylate.
(iv) Tricyclodecenyl group-containing polymerizable unsaturated monomers, such as tricyclodecenyl (meth)acrylate.
(v) Aromatic ring-containing polymerizable unsaturated monomers, such as benzyl (meth)acrylate, styrene, α-methylstyrene, and vinyltoluene.
(vi) Alkoxysilyl group-containing polymerizable unsaturated monomers, such as vinyltrimethoxysilane, vinyltriethoxysilane, vinyltris(2-methoxyethoxy)silane, γ-(meth)acryloyloxypropyltrimethoxysilane, and γ-(meth)acryloyloxypropyltriethoxysilane.
(vii) Fluorinated alkyl group-containing polymerizable unsaturated monomers, such as perfluoroalkyl (meth)acrylates such as perfluorobutylethyl (meth)acrylate and perfluorooctylethyl (meth)acrylate; and fluoroolefin.
(viii) Polymerizable unsaturated monomers containing a photo-polymerizable functional group such as maleimide.
(ix) Vinyl compounds, such as N-vinylpyrrolidone, ethylene, butadiene, chloroprene, vinyl propionate, and vinyl acetate.
(x) Carboxyl group-containing polymerizable unsaturated monomers, such as (meth)acrylic acid, maleic acid, crotonic acid, and β-carboxyethyl (meth)acrylate.
(xi) Nitrogen-containing polymerizable unsaturated monomers, such as (meth)acrylonitrile, (meth)acrylamide, N,N-dimethylaminoethyl (meth)acrylate, N,N-diethylaminoethyl (meth)acrylate, N,N-dimethylaminopropyl (meth)acrylamide, methylene bis(meth)acrylamide, ethylene bis(meth)acrylamide, and addition products of glycidyl (meth)acrylate with amine compounds.
(xii) Polymerizable unsaturated monomers containing at least two polymerizable unsaturated groups in one molecule, such as allyl (meth)acrylate, ethylene glycol di(meth)acrylate, 1,4-butanediol di(meth)acrylate, neopentyl glycol di(meth)acrylate, and 1,6-hexanediol di(meth)acrylate.
(xiii) Epoxy group-containing polymerizable unsaturated monomers, such as glycidyl (meth)acrylate, β-methylglycidyl (meth)acrylate, 3,4-epoxycyclohexylmethyl (meth)acrylate, 3,4-epoxycyclohexylethyl (meth)acrylate, 3,4-epoxycyclohexylpropyl (meth)acrylate, and allyl glycidyl ether.
(xiv) (Meth)acrylates containing polyoxyethylene chains with alkoxy groups at terminals.
(xv) Sulfonic acid group-containing polymerizable unsaturated monomers, such as 2-acrylamido-2-methylpropane-sulfonic acid, 2-sulfoethyl (meth)acrylate, allylsulfonic acid, and 4-styrenesulfonic acid; and sodium salts and ammonium salts of these sulfonic acids.
(xvi) Phosphoric acid group-containing polymerizable unsaturated monomers, such as acid phosphooxyethyl (meth)acrylate, acid phosphooxypropyl (meth)acrylate, acid phosphooxypoly(oxyethylene)glycol (meth)acrylate, and acid phosphooxypoly(oxypropylene)glycol (meth)acrylate.
(xvii) Ultraviolet absorbing functional group-containing polymerizable unsaturated monomers, such as 2-hydroxy-4-(3-methacryloyloxy-2-hydroxypropoxy)benzophenone, 2-hydroxy-4-(3-acryloyloxy-2-hydroxypropoxy)benzophenone, 2,2′-dihydroxy-4-(3-methacryloyloxy-2-hydroxypropoxy)benzophenone, 2,2′-dihydroxy-4-(3-acryloyloxy-2-hydroxypropoxy)benzophenone, and 2-[2-hydroxy-5-[2-(methacryloyloxy)ethyl]phenyl]-2H-benzotriazole.
(xviii) Photostable polymerizable unsaturated monomers, such as 4-(meth)acryloyloxy-1,2,2,6,6-pentamethylpiperidine, 4-(meth)acryloyloxy-2,2,6,6-tetramethylpiperidine, 4-cyano-4-(meth)acryloylamino-2,2,6,6-tetramethylpiperidine, 1-(meth)acryloyl-4-(meth)acryloylamino-2,2,6,6-tetramethylpiperidine, 1-(meth)acryloyl-4-cyano-4-(meth)acryloylamino-2,2,6,6-tetramethylpiperidine, 4-crotonoyloxy-2,2,6,6-tetramethylpiperidine, 4-crotonoylamino-2,2,6,6-tetramethylpiperidine, and 1-crotonoyl-4-crotonoyloxy-2,2,6,6-tetramethylpiperidine.
(xix) Carbonyl group-containing polymerizable unsaturated monomers, such as acrolein, diacetonacrylamide, diacetonmethacrylamide, acetoacetoxyethyl methacrylate, formylstyrol, and vinyl alkyl ketones having 4 to 7 carbon atoms (for example, vinyl methyl ketone, vinyl ethyl ketone, and vinyl butyl ketone).
(xx) Acid anhydride group-containing polymerizable unsaturated monomers, such as maleic anhydride, itaconic anhydride, and citraconic anhydride.

The hydroxy group-containing acrylic resin (C) preferably has a hydroxy group value of 10 mgKOH/g to 150 mgKOH/g, and more preferably 50 mgKOH/g to 100 mgKOH/g. An acid value is preferably 150 mgKOH/g or less, and more preferably 145 mgKOH/g or less. A weight average molecular weight is preferably 1000 to 100000, and more preferably 2000 to 60000.

In the present specification, the weight average molecular weight of the hydroxy group-containing acrylic resin (C) is a value determined by converting a retention time (retention volume) measured using a gel permeation chromatograph (GPC) into a molecular weight of polystyrene from a retention time (retention volume) of standard polystyrene having a well-known molecular weight measured under the same conditions. Specifically, the measurement may be performed under conditions of a mobile phase of tetrahydrofuran, a measurement temperature of 40° C., and a flow rate of 1 mL/min by using “HLC-8120GPC” (trade name, manufactured by Tosoh Corporation) as a gel permeation chromatograph device, using a total of four columns that are “TSKgel G4000HXL”, “TSKgel G3000HXL”, “TSKgel G2500HXL”, and “TSKgel G2000HXL” (all of which are trade names, manufactured by Tosoh Corporation) as columns, and using a differential refractometer as a detector.

A content of the hydroxy group-containing acrylic resin (C) in the glitter pigment dispersion (Y) is preferably 0.5 mass % to 10 mass %, and more preferably 1 mass % to 5 mass % of the total solid content of the glitter pigment dispersion (Y), in terms of forming a white metallic multilayer coating film having a high gloss at a highlight, a high lightness throughout the film from the highlight to a shade, and an excellent reworkability.

### Viscosity Modifier (D)

As the viscosity modifier (D) in the glitter pigment dispersion (Y), a well-known viscosity modifier can be used. Examples thereof include silica fine powder, a mineral viscosity modifier, barium sulfate atomization powder, a polyamide viscosity modifier, an organic resin fine particle viscosity modifier, a diurea viscosity modifier, a urethane association-type viscosity modifier, a polyacrylic acid viscosity modifier which is of an acrylic swelling-type, and a cellulose viscosity modifier. Among these, in terms of obtaining a coating film having an excellent metallic luster, a mineral viscosity modifier, a polyacrylic acid viscosity modifier, or a cellulose viscosity modifier is particularly preferably used.

Examples of the mineral viscosity modifier include swelling laminar silicate that has a 2:1 type crystal structure. Specific examples thereof include a smectite group clay mineral, such as natural or synthetic montmorillonite, saponite, hectorite, stevensite, beidellite, nontronite, bentonite, and laponite; a swelling mica group clay mineral, such as Na-type tetrasilicic fluorine mica. Li-type tetrasilicic fluorine mica, Na salt-type fluorine taeniolite, and Li-type fluorine taeniolite; and vermiculite; or substitution products and derivatives thereof, or mixtures thereof.

Examples of the polyacrylic acid viscosity modifier include sodium polyacrylate, and a polyacrylic acid-(meth)acrylic acid ester copolymer.

Examples of commercial products of the polyacrylic acid viscosity modifier include “Primal ASE-60”, “Primal TT615”, and “Primal RM5” (trade names, manufactured by The Dow Chemical Company); “SN Thickener 613”, “SN Thickener 618”, “SN Thickener 630”, “SN Thickener 634”, and “SN Thickener 636” (trade names, manufactured by San Nopco Limited). An acid value of a solid content of the polyacrylic acid viscosity modifier is 30 mgKOH/g to 300 mgKOH/g, and preferably 80 mgKOH/g to 280 mgKOH/g.

Examples of the cellulose viscosity modifier include carboxymethylcellulose, methylcellulose, hydroxyethylcellulose, hydroxyethylmethylcellulose, hydroxypropylmethylcellulose, methylcellulose, and cellulose nanofiber gel.

These viscosity modifiers may be used alone or in a suitable combination of two or more thereof.

A content of the viscosity modifier (D) in the glitter pigment dispersion (Y) is preferably 5 mass % to 30 mass %, and more preferably 10 mass % to 25 mass % of the total solid content of the glitter pigment dispersion (Y), in terms of forming a white metallic multilayer coating film having a high gloss at a highlight.

### Other Components

The glitter pigment dispersion (Y) may further suitably contain, if necessary, a resin other than the hydroxy group-containing acrylic resin (C), an organic solvent, a pigment dispersant, an anti-settling agent, an antifoaming agent, an ultraviolet absorber, and a surface modifier.

Examples of the resin other than the hydroxy group-containing acrylic resin (C) include an acrylic resin that does not contain a hydroxy group, a polyester resin that may contain a hydroxy group, an alkyd resin that may contain a hydroxy group, and a urethane resin that may contain a hydroxy group. Among these, a hydroxy group-containing polyester resin is preferably contained.

When the glitter pigment dispersion (Y) contains a hydroxy group-containing polyester resin, a content of the hydroxy group-containing polyester resin is preferably 10 mass % to 60 mass %, and more preferably 20 mass % to 50 mass % of the total solid content of the glitter pigment dispersion (Y).

### Applying Glitter Pigment Dispersion (Y)

The glitter pigment dispersion (Y) is prepared by mixing and dispersing the above components, and preferably the solid content at the time of application is adjusted to 0.1 mass % to 7 mass %, and preferably 1 mass % to 5 mass % based on the glitter pigment dispersion (Y).

The viscosity of the glitter pigment dispersion (Y) is preferably 30 mPa s to 1000 mPa-s as measured at 60 rpm after 1 minute at a temperature of 20° C. using a B-type viscometer (sometimes, referred to as a “B60 value” in the present specification). The viscometer to be used in this case is “LVDV-I” (trade name, manufactured by BROOKFIELD. B-type viscometer).

The glitter pigment dispersion (Y) can be applied by a method such as electrostatic coating, air spray coating, or airless spray coating. In the method for producing a multilayer coating film of the present invention, rotary atomization type electrostatic coating is particularly preferable.

### [Step (3)]

In the present invention, the step (3) is a step of applying a two-component clear coating (Z) including a hydroxy group-containing acrylic resin and a polyisocyanate compound on or above the glitter coating film formed in the step (2) to form a clear coating film.

### Two-Component Clear Coating (Z)

The two-component clear coating (Z) contains the hydroxy group-containing acrylic resin and the polyisocyanate compound.

The above hydroxy group-containing acrylic resin can be produced by copolymerizing, for example, a hydroxy group-containing polymerizable unsaturated monomer with other polymerizable unsaturated monomers that are copolymerizable with the hydroxy group-containing polymerizable unsaturated monomer by using a well-known method, such as a solution polymerization method in an organic solvent, or an emulsion polymerization method in water.

As the above hydroxy group-containing polymerizable unsaturated monomer, the hydroxy group-containing polymerizable unsaturated monomer described in the description section for the hydroxy group-containing acrylic resin (C) can be used.

As the other polymerizable unsaturated monomers that are copolymerizable with the hydroxy group-containing polymerizable unsaturated monomer, the other polymerizable unsaturated monomers that are copolymerizable with the hydroxy group-containing polymerizable unsaturated monomers described in the description section for the above hydroxy group-containing acrylic resin (C) can be used.

The polyisocyanate compound is a compound having at least two isocyanate groups in one molecule. Examples thereof include an aliphatic polyisocyanate, an alicyclic polyisocyanate, an aromatic-aliphatic polyisocyanate, an aromatic polyisocyanate, and derivatives of these polyisocyanates.

Examples of the above aliphatic polyisocyanate include aliphatic diisocyanates, such as trimethylene diisocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate, dimer acid diisocyanate, and 2,6-diisocyanatomethyl hexanoate (common name: lysine diisocyanate); and aliphatic triisocyanates, such as 2,6-diisocyanatohexanoic acid 2-isocyanatoethyl, 1,6-diisocyanato-3-isocyanatomethylhexane, 1,4,8-triisocyanatooctane, 1,6,11-triisocyanatoundecane, 1,8-diisocyanato-4-isocyanatomethyloctane, 1,3,6-triisocyanatohexane, and 2,5,7-trimethyl-1,8-diisocyanato-5-isocyanatomethyloctane.

Examples of the alicyclic polyisocyanate include alicyclic diisocyanates, such as 1,3-cyclopentene diisocyanate, 1,4-cyclohexane diisocyanate, 1,3-cyclohexane diisocyanate, 3-isocyanatomethyl-3,5,5-trimethylcyclohexyl isocyanate (common name: isophorone diisocyanate), 4-methyl-1,3-cyclohexylene diisocyanate (common name: hydrogenated TDI), 2-methyl-1,3-cyclohexylene diisocyanate, 1,3- or 1,4-bis(isocyanatomethyl)cyclohexane (common name: hydrogenated xylylene diisocyanate) or mixtures thereof, methylenebis(4,1-cyclohexanediyl)diisocyanate (common name: hydrogenated MDI), and norbornane diisocyanate; and alicyclic triisocyanates, such as 1,3,5-triisocyanatocyclohexane, 1,3,5-trimethylisocyanatocyclohexane, 2-(3-isocyanatopropyl)-2,5-di(isocyanatomethyl)-bicyclo(2.2.1)heptane, 2-(3-isocyanatopropyl)-2,6-di(isocyanatomethyl)-bicyclo(2.2.1)heptane, 3-(3-isocyanatopropyl)-2,5-di(isocyanatomethyl)-bicyclo(2.2.1)heptane, 5-(2-isocyanatoethyl)-2-isocyanatomethyl-3-(3-isocyanatopropyl)-bicyclo(2.2.1)heptane, 6-(2-isocyanatoethyl)-2-isocyanatomethyl-3-(3-isocyanatopropyl)-bicyclo(2.2.1)heptane, 5-(2-isocyanatoethyl)-2-isocyanatomethyl-2-(3-isocyanatopropyl)-bicyclo(2.2.1)heptane, and 6-(2-isocyanatoethyl)-2-isocyanatomethyl-2-(3-isocyanatopropyl)-bicyclo(2.2.1)heptane.

Examples of the aromatic-aliphatic polyisocyanate include aromatic-aliphatic diisocyanates, such as methylenebis(4,1-phenylene)diisocyanate (common name: MDI), 1,3- or 1,4-xylylene diisocyanate or mixtures thereof, ω,ω′-diisocyanato-1,4-diethylbenzene, and 1,3- or 1,4-bis(1-isocyanato-1-methylethyl)benzene (common name: tetramethylxylylene diisocyanate) or mixtures thereof, and aromatic-aliphatic triisocyanates, such as 1,3,5-triisocyanatomethylbenzene.

Examples of the aromatic polyisocyanate include aromatic diisocyanates, such as m-phenylene diisocyanate, p-phenylene diisocyanate, 4,4′-diphenyldiisocyanate, 1,5-naphthalene diisocyanate, 2,4-tolylene diisocyanate (common name: 2,4-TDI), or 2,6-tolylene diisocyanate (common name: 2,6-TDI) or mixtures thereof, 4,4′-toluidine diisocyanate, and 4,4′-diphenylether diisocyanate; aromatic triisocyanates, such as triphenylmethane-4,4′,4″-triisocyanate, 1,3,5-triisocyanatobenzene, and 2,4,6-triisocyanatotoluene; and aromatic tetraisocyanates, such as 4,4′-diphenylmethane-2,2′,5,5′-tetraisocyanate.

Examples of derivatives of the polyisocyanates include dimers, trimers, biurets, allophanates, urethodiones, urethoimines, isocyanurates, oxadiazinetriones, polymethylene polyphenyl polyisocyanates (crude MDI, polymeric MDI), and crude TDI of the above polyisocyanates.

These polyisocyanates and the derivatives thereof may be used alone or in a combination of two or more thereof.

In the present invention, an equivalent ratio (OH/NCO) of the hydroxy group of the hydroxy group-containing acrylic resin to the isocyanate group of the polyisocyanate compound is preferably 0.5 to 2.0, and more preferably 0.8 to 1.5, in terms of curability, scratch resistance, and the like of the coating film.

An additive, such as a solvent (for example, water and an organic solvent), a curing catalyst, an antifoaming agent, and an ultraviolet absorber can be further suitably blended in the clear coating (Z), if necessary.

A form of the clear coating (Z) is not particularly limited, but is usually used as an organic solvent coating composition. Examples of the organic solvent to be used in this case include various organic solvents for coatings, such as aromatic or aliphatic hydrocarbon solvents; ester solvents; ketone solvents; and ether solvents. As the organic solvent to be used herein, one used in preparation of a hydroxy group-containing resin may be used as it is, or other organic solvents may be further suitably added.

A solid concentration of the clear coating (Z) is preferably about 30 mass % to 70 mass %, and more preferably about 40 mass % to 60 mass %.

A applying method of the clear coating (Z) is not particularly limited, and examples thereof include air spray coating, airless spray coating, rotary atomization coating, or curtain coating. In these applying methods, an electrostatic charge may be applied, if necessary. Among these, rotary atomization coating using an electrostatic charge is preferable. A application amount of the clear coating (Z) is generally preferably an amount in which a cured film thickness is about 10 μm to 50 μm.

When the clear coating (Z) is applied, it is preferable to suitably adjust the viscosity of the clear coating (Z) to be within a viscosity range suitable for the applying method by using a solvent, such as an organic solvent. For example, in rotary atomization coating using an electrostatic charge, the viscosity can be adjusted to be within a range of about 15 seconds to 60 seconds by measurement performed by a Ford cup No. 4 viscometer at 20° C.

### [Step (4)]

In the present invention, the step (4) is a step of heating the uncured base coating film, the uncured glitter coating film, and the uncured clear coating film formed in the steps (1) to (3), respectively, to simultaneously cure these three coating films.

The above heating can be performed by a well-known method. For example, a drying furnace, such as a hot-blast furnace, an electric furnace, or an infrared beam heating furnace, can be used. A heating temperature is preferably within a range of 70° C. to 150° C., and more preferably 80° C. to 140° C. A heating time is not particularly limited, but is preferably within a range of 10 minutes to 40 minutes, and more preferably 20 minutes to 30 minutes.

### <Multilayer Coating Film>

A multilayer coating film formed by the producing method of the present invention is a multilayer coating film including:
an electrodeposition coating film;
a base coating film;
a glitter coating film, and
a clear coating film in this order, in which
the base coating film has a film thickness of 20 μm to 35 μm and a lightness L*45 of 85 to 95,
the glitter coating film includes an aluminum flake pigment (A) and titanium oxide (B), and has a film thickness of 0.01 μm to 1.0 μm,
a content of the titanium oxide (B) in the glitter coating film is 10 mass % to 20 mass %, and a mass ratio of the aluminum flake pigment (A)/the titanium oxide (B) is 0.8 to 1.2,
the clear coating film includes a cured product of a hydroxy group-containing acrylic resin and a polyisocyanate compound, and
in the multilayer coating film, a lightness L*45 is within a range of 75 to 85, a 60-degree specular gloss is within a range of 95 to 105, and a flip-flop value is within a range of 0.5 to 0.7.

In the multilayer coating film formed by the producing method of the present invention, the lightness L*45 is within the range of 75 to 85, the 60-degree specular gloss is within the range of 95 to 105, the flip-flop value is within the range of 0.5 to 0.7, and reworkability is excellent. That is, according to the producing method of the present invention, a white metallic multilayer coating film having a high gloss at a highlight, a high lightness throughout the film from the highlight to a shade, and an excellent reworkability can be obtained.

The above 60-degree specular gloss refers to a ratio of specular reflection from an object surface to specularly reflected light from a reference surface (a glass having a refractive index of 1.567), and is a value defined in JIS-Z8741. Specifically, the 60-degree specular gloss is determined in such a manner that a light beam of a specified opening angle is made incident on a measuring sample surface at a specified incident angle, and a light beam of the specified opening angle reflected in a direction of the specular reflection is measured by an optical receiver, and the 60-degree specular gloss is a numerical value measured using a so-called glossmeter. In the present specification, a value measured using a glossmeter (micro-TRI-gloss, manufactured by BYK-Gardner) is defined as the 60-degree specular gloss (60° gloss).

The flip-flop value is a numerical value representing magnitude of a lightness change according to an observation angle. Specifically, spectral reflectances are measured at receiving angles of 15 degrees and 45 degrees with respect to specularly reflected light of light illuminated at an angle of 45 degrees with respect to the coating film using an MA-68II multi-angle spectrophotometer (trade name, manufactured by Videojet X-Rite K.K.), and Y values (respectively set as Y15 and Y45) in an XYZ color system calculated from the spectral reflectances are calculated, and a numerical value calculated using the following formula is defined as the flip-flop value.

$$Flip - flop value ( FF value ) = 2 \times ( Y 15 - Y 45 ) / ( Y 15 + Y 45 )$$

### EXAMPLES

Hereinafter, the present invention will be described more specifically with reference to Examples and Comparative Examples. However, the present invention is not limited to these Examples. Note that “part” and “%” are all based on mass.

### Production of Hydroxy Group-Containing Acrylic Resin (C)

### Production Example 1

In a reaction vessel equipped with a thermometer, a thermostat, a stirrer, a reflux condenser, a nitrogen introduction tube, and a dropping funnel, 35 parts of propylene glycol monopropyl ether was placed, and a temperature was raised to 85° C., and then a mixture of 30 parts of methyl methacrylate, 20 parts of 2-ethylhexyl acrylate, 29 parts of n-butyl acrylate, 15 parts of 2-hydroxyethyl acrylate, 6 parts of acrylic acid, 15 parts of propylene glycol monopropyl ether, and 2.3 parts of 2,2′-azobis(2,4-dimethylvaleronitrile) was added dropwise over 4 hours, followed by aging for 1 hour after the end of the dropwise addition. Then, a mixture of 10 parts of propylene glycol monopropyl ether and 1 part of 2,2′-azobis(2,4-dimethylvaleronitrile) was added dropwise over 1 hour, followed by aging for 1 hour after the end of the dropwise addition. Furthermore, 7.4 parts of diethanolamine was added to obtain a hydroxy group-containing acrylic resin solution (C-1) having a solid content of 55%. The obtained hydroxy group-containing acrylic resin had an acid value of 47 mgKOH/g, a hydroxy group value of 72 mgKOH/g, and a weight average molecular weight of 58,000.

### Production of Hydroxy Group-Containing Polyester Resin (R)

### Production Example 2

In a reaction vessel equipped with a thermometer, a thermostat, a stirrer, a reflux condenser, and a water separator, 109 parts of trimethylolpropane, 141 parts of 1,6-hexanediol, 126 parts of 1,2-cyclohexanedicarboxylic anhydride, and 120 parts of adipic acid were placed, and a temperature was raised from 160° C. to 230° C. over 3 hours, and then a condensation reaction was carried out at 230° C. for 4 hours. Next, in order to introduce a carboxyl group, 38.3 parts of trimellitic anhydride was added to the obtained condensation reaction product, and the mixture was reacted at 170° C. for 30 minutes, and then diluted with 2-ethyl-1-hexanol to obtain a hydroxy group-containing polyester resin solution (R-1) having a solid content of 70%. The obtained hydroxy group-containing polyester resin had an acid value of 46 mgKOH/g, a hydroxy group value of 150 mgKOH/g, and a number average molecular weight of 1400.

### Production of Titanium Oxide Pigment Dispersion (P)

### Production Example 3

In a stirring mixing vessel, 3.6 parts of the hydroxy group-containing acrylic resin solution (C-1) (2 parts of solid), 15 parts of “JR-903” (trade name, rutile type titanium oxide pigment, manufactured by Tayca Corporation), and 15.4 parts of distilled water were placed and mixed uniformly, and 2-(dimethylamino)ethanol was further added to adjust pH to 7.5. The obtained mixture was placed in a 225 ml resin bottle, 130 parts of zirconia beads having a diameter of 1.5 mm were added thereto, the bottle was hermetically sealed, and the mixture was dispersed for 120 minutes using a shaker type paint conditioner. After dispersion, the obtained dispersion was filtered through a 100-mesh wire screen to remove the zirconia beads, thereby obtaining a titanium oxide pigment dispersion (P-1) having a solid content of 50%.

### Production Examples 4 to 7

Titanium oxide pigment dispersions (P-2) to (P-5) were obtained in the same manner as in Production Example 3, except that the blending shown in Table 1 was used.

TABLE 1
Value in parentheses indicates solid content

| | | Production Example | | | | |
|---|---|---|---|---|---|---|
| | | 3 | 4 | 5 | 6 | 7 |
| Name of titanium oxide | | P-1 | P-2 | P-3 | P-4 | P-5 |
| pigment dispersion | | | | | | |
| Blending | Hydroxy | 3.6(2) | 3.6(2) | 3.6(2) | 3.6(2) | 3.6(2) |
| | group- | | | | | |
| | containing | | | | | |
| | acrylic | | | | | |
| | resin solution | | | | | |
| | (C-1) | | | | | |
| | “JR-903” | 15(15) | 18(18) | 12(12) | 22(22) | 8(8) |
| | Distilled water | 15.4 | 18.4 | 12.4 | 22.4 | 8.4 |

### Production of Glitter Pigment Dispersion (Y)

### Production Example 8

Distilled water (2425 parts), 31.9 parts (15 parts of solid) of “Alpaste EMERAL EMR-B6360” (trade name, non-leafing aluminum, manufactured by Toyo Aluminium K.K., average particle size D50: 10.3 μm, thickness: 0.19 μm, aluminum content: 47%, the surface was treated with silica), 34 parts (17 parts of solid) of titanium oxide pigment dispersion (P-1), 53.6 parts (15 parts of solid) of “Acrysol ASE-60” (polyacrylic acid viscosity modifier, manufactured by The Dow Chemical Company, solid content: 28%), 250 parts (5 parts of solid) of “Rheocrysta” (trade name, cellulose viscosity modifier, manufactured by Dai-Ichi Kogyo Seivaku Co., Ltd., solid content: 2%), 57 parts (40 parts of solid) of the hydroxy group-containing polyester resin solution (R-1), and 8 parts (8 parts of solid) of “BYK348” (trade name, manufactured by BYK-Chemie, silicone surface modifier, non-volatile content: 100% by mass) were blended, stirred, and mixed, thereby obtaining a glitter pigment dispersion (Y-1) having a solid content of 3.5% by mass.

### Production Examples 9 to 16

Glitter pigment dispersions (Y-2) to (Y-9) were obtained in the same manner as in Production Example 8, except that the blending shown in Table 2 was used.

A content of titanium oxide (B) in a total solid content of a glitter dispersion (Y) in Table 2 is the same as the content of titanium oxide (B) in the glitter coating film.

TABLE 2
Value in parentheses indicates solid content

| Production Example No. | | | | 8 | 9 | 10 | 11 |
|---|---|---|---|---|---|---|---|
| Name of glitter pigment dispersion (Y) | | | | Y-1 | Y-2 | Y-3 | Y-4 |
| Blending | Distilled water | | | 2425 | 2425 | 2425 | 2420 |
| | Aluminum flake pigment | | “Alpaste | 31.9 | 36.2 | 27.7 | 38.3 |
| | (A) | | EMERAL EMR- | (15) | (17) | (13) | (18) |
| | | | B6360” | | | | |
| | Titanium | Name of titanium oxide pigment | | P-1 | P-1 | P-1 | P-2 |
| | oxide | dispersion | | | | | |
| | pigment | Hydroxy | Hydroxy group- | 3.6 | 3.6 | 3.6 | 3.6 |
| | dispersion | group- | containing | (2) | (2) | (2) | (2) |
| | | containing | acrylic resin | | | | |
| | | acrylic resin | solution (C-1) | | | | |
| | | solution (C) | | | | | |
| | | Titanium oxide | “JR-903” | 15 | 15 | 15 | 18 |
| | | (B) | | (15) | (15) | (15) | (18) |
| | | Distilled water | | 15.4 | 15.4 | 15.4 | 18.4 |
| | Viscosity modifier (D) | | “Acrysol ASE- | 53.6 | 53.6 | 53.6 | 53.6 |
| | | | 60” | (15) | (15) | (15) | (15) |
| | | | “Rheocrysta” | 250 | 250 | 250 | 250 |
| | | | | (5) | (5) | (5) | (5) |
| | Hydroxy group-containing | | Hydroxy group- | 57 | 54.3 | 60 | 48.6 |
| | polyester resin solution (R) | | containing | (40) | (38) | (42) | (34) |
| | | | polyester resin | | | | |
| | | | solution (R-1) | | | | |
| | Surface modifier | | “BYK348” | 8 | 8 | 8 | 8 |
| | | | | (8) | (8) | (8) | (8) |

| | | | | | |
|---|---|---|---|---|---|
| State | Solid content (mass %) | 3.5 | 3.5 | 3.5 | 3.5 |
| | Content (mass %) of titanium oxide (B) in total | 15.0 | 15.0 | 15.0 | 18.0 |
| | solid content of glitter dispersion (Y) | | | | |
| | Mass ratio of aluminum flake pigment | 1.00 | 1.13 | 0.87 | 1.00 |
| | (A)/titanium oxide (B) | | | | |

Value in parentheses indicates solid content

| Production Example No. | | | | 12 | 13 | 14 | 15 | 16 |
|---|---|---|---|---|---|---|---|---|
| Name of glitter pigment dispersion (Y) | | | | Y-5 | Y-6 | Y-7 | Y-8 | Y-9 |
| Blending | Distilled water | | | 2430 | 2420 | 2430 | 2410 | 2435 |
| | Aluminum flake pigment | | “Alpaste | 25.5 | 42.6 | 21.3 | 46.8 | 17.0 |
| | (A) | | EMERAL EMR- | (12) | (20) | (10) | (22) | (8) |
| | | | B6360” | | | | | |
| | Titanium | Name of titanium oxide pigment | | P-3 | P-1 | P-1 | P-4 | P-5 |
| | oxide | dispersion | | | | | | |
| | pigment | Hydroxy | Hydroxy group- | 3.6 | 3.6 | 3.6 | 3.6 | 3.6 |
| | dispersion | group- | containing | (2) | (2) | (2) | (2) | (2) |
| | | containing | acrylic resin | | | | | |
| | | acrylic resin | solution (C-1) | | | | | |
| | | solution (C) | | | | | | |
| | | Titanium oxide | “JR-903” | 12 | 15 | 15 | 22 | 8 |
| | | (B) | | (12) | (15) | (15) | (22) | (8) |

| | | | | | |
|---|---|---|---|---|---|
| Distilled water | 12.4 | 15.4 | 15.4 | 22.4 | 8.4 |

| | | | | | | |
|---|---|---|---|---|---|---|
| Viscosity modifier (D) | “Acrysol ASE- | 53.6 | 53.6 | 53.6 | 53.6 | 53.6 |
| | 60” | (15) | (15) | (15) | (15) | (15) |
| | “Rheocrysta” | 250 | 250 | 250 | 250 | 250 |
| | | (5) | (5) | (5) | (5) | (5) |
| Hydroxy group-containing | Hydroxy group- | 65.7 | 50 | 64.3 | 37.1 | 77.1 |
| polyester resin solution (R) | containing | | | | | |
| | polyester resin | (46) | (35) | (45) | (26) | (54) |
| | solution (R-1) | | | | | |
| Surface modifier | “BYK348” | 8 | 8 | 8 | 8 | 8 |
| | | (8) | (8) | (8) | (8) | (8) |

| | | | | | | |
|---|---|---|---|---|---|---|
| State | Solid content (mass %) | 3.5 | 3.5 | 3.5 | 3.5 | 3.5 |
| | Content (mass %) of titanium oxide (B) in total | 12.0 | 15.0 | 15.0 | 22.0 | 8.0 |
| | solid content of glitter dispersion (Y) | | | | | |
| | Mass ratio of aluminum flake pigment | 1.00 | 1.33 | 0.67 | 1.00 | 1.00 |
| | (A)/titanium oxide (B) | | | | | |

### <Preparation of Object to be Coated>

A cationic electrodeposition coating “Elecron GT-10” (trade name, manufactured by Kansai Paint Co., Ltd., a blocked polyisocyanate compound was used in an epoxy resin polyamine cationic resin as a crosslinking agent) was applied by electrodeposition to a degreased and zinc phosphate-treated steel plate (JISG3141, size: 400 mm×300 mm×0.8 mm) to have a film thickness of 20 μm based on the cured coating film, and the obtained film was heated at 170° C. for 20 minutes to be cured by crosslinking, thereby forming an electrodeposition coating film, which was used as an object to be coated.

### Preparation of Test Plate

### Example 1

Step (1): On the object to be coated, a base coating (X-1) “WP-580Z N-9.0” (trade name, Kansai Paint Co., Ltd., polyester resin aqueous intermediate coating, L*45 value of the obtained coating film: 90) was applied by electrostatic coating using a rotary atomization-type bell-shaped coating device until a cured film thickness was 27 μm, followed by standing for 3 minutes to form a base coating film.

Step (2): Next, the glitter pigment dispersion (Y-1) prepared as described above was applied on the base coating film using a robot bell produced by ABB under conditions of a booth temperature of 23° C. and humidity of 68% until a dry coating film thickness was 0.5 μm. The obtained film stood for 3 minutes, and then was preheated at 80° C. for 3 minutes to form a glitter coating film.

Step (3): Next, a clear coating (Z-1) “KINO6510” (trade name, manufactured by Kansai Paint Co., Ltd., hydroxy group/isocyanate group curing type acrylic resin and urethane resin type two-component organic solvent coating) was applied on the glitter coating film by using a robot bell (produced by ABB) under conditions of a booth temperature of 23° C. and humidity of 68% until a dry coating film thickness was 30 μm, thereby forming a clear coating film.

Step (4): Next, the obtained clear coating film stood at room temperature for 7 minutes, and then was heated in a hot-air circulation-type dryer at 140° C. for 30 minutes to simultaneously dry the multilayer coating films, thereby obtaining a test plate.

Here, a film thickness of the dry coating film was calculated from the following formula. The same applies to the following Examples.

$$x = ( sc * 10000 ) / ( S * sg )$$

x: film thickness [μm]
sc: coated solid content [g]
S: evaluation area [cm²] of coated solid content
sg: coating film specific gravity Ig/cm³|.

### Examples 2 to 9, Comparative Examples 1 to 8

Test plates were obtained in the same manner as in Example 1, except that coatings and film thicknesses shown in Table 3 or 4 were used.

The base coating (X-2) in the table is as follows.

(X-2): “WP-522H N-8.0” (trade name, manufactured by Kansai Paint Co., Ltd., polyester resin aqueous intermediate coating, L*45 value of obtained coating film: 80).

### <Evaluation of Coating Film>

The coating film of each test plate obtained as described above was evaluated by the following method, and results were shown in Tables 3 and 4.

### <Lightness L*45>

The values used were calculated from the spectral reflectance measured using a multi-angle spectrophotometer “MA-68II” (trade name, manufactured by Videojet X-Rite K.K.).

### <60° Specular Gloss>

Measurement was performed using a glossmeter “micro-TRI-gloss” (trade name, manufactured by BYK-Gardner).

### <Flip-Flop Value>

A spectral reflectance was measured at receiving angles of 15 degrees and 45 degrees with respect to specularly reflected light of light illuminated at an angle of 45 degrees with respect to the coating film using the MA-68II multi-angle spectrophotometer (trade name, manufactured by Videojet X-Rite K.K.), and Y values (respectively set as Y15 and Y45) in an XYZ color system calculated from the spectral reflectance were calculated, and calculation was performed using the following formula.

$$Flip - flop value ( FF value ) = 2 \times ( Y 15 - Y 45 ) / ( Y 15 + Y 45 )$$

### <Reworkability>

A surface of the multilayer coating film of each test plate obtained as described above was polished and removed in a circle with a radius of approximately 2 cm using #600 waterproof abrasive paper and #1200 waterproof abrasive paper until a surface of the electrodeposition coating film in the center of the circle was exposed.

Next, “Retan PG Eco Bokashi Leveling Agent” (trade name, manufactured by Kansai Paint Co., Ltd., organic solvent coating composition) was applied with an air spray in a circle with a radius of approximately 15 cm around a polished region to have a thickness of 3 μm, followed by standing for 1 minute.

Next, “Retan PG Hybrid Eco 531 White Base” (trade name, manufactured by Kansai Paint Co., Ltd., hydroxy group/isocyanate curing organic solvent coating composition) was applied with an air spray in a circle with a radius of approximately 10 cm around the polished region to have a thickness of 40 μm, followed by standing for 5 minutes.

Next, “Retan PG Hybrid Eco 832 Silky Flash M Base” (trade name, manufactured by Kansai Paint Co., Ltd., hydroxy group/isocyanate curing organic solvent coating composition) was applied with an air spray in a circle with a radius of approximately 15 cm around the polished region to have a thickness of 1 μm, followed by standing for 2 minutes.

Next, “Retan PG Eco HS Clear” (trade name, manufactured by Kansai Paint Co., Ltd., hydroxy group/isocyanate curing organic solvent coating composition) was applied with an air spray in a circle with a radius of approximately 20 cm around the polished region to have a thickness of 40 μm, the obtained film stood for 5 minutes, and then was heated in a hot-air circulation-type dryer at 60° C. for 8 minutes, and reworkability was evaluated.

Appearances of a region where the coating film was removed by polishing and a region where the coating film was not removed by polishing were evaluated according to the following criteria. A and B are acceptable.

A represents that no difference is observed between the region where the coating film was removed by polishing and the region where the coating film was not removed by polishing.

B represents that a slight difference is observed between the region where the coating film was removed by polishing and the region where the coating film was not removed by polishing, but there are no problems in practice.

C represents that a clear difference is observed between the region where the coating film was removed by polishing and the region where the coating film was not removed by polishing.

TABLE 3

| | Example | | | | | | | | |
|---|---|---|---|---|---|---|---|---|---|
| | 1 | 2 | 3 | 4 | 5 | 6 | 7 | 8 | 9 |
| Name of base coating (X) | X-1 | X-1 | X-1 | X-1 | X-1 | X-1 | X-1 | X-1 | X-1 |
| Film thickness (μm) of base coating | 27 | 22 | 33 | 27 | 27 | 27 | 27 | 27 | 27 |
| film | | | | | | | | | |
| Lightness L*45 of base coating film | 90 | 90 | 90 | 90 | 90 | 90 | 90 | 90 | 90 |
| Name of glitter pigment dispersion | Y-1 | Y-1 | Y-1 | Y-2 | Y-3 | Y-4 | Y-5 | Y-1 | Y-1 |
| (Y) | | | | | | | | | |
| Film thickness (μm) of glitter coating | 0.5 | 0.5 | 0.5 | 0.5 | 0.5 | 0.5 | 0.5 | 0.2 | 0.8 |
| film | | | | | | | | | |
| Name of clear coating (Z) | Z-1 | Z-1 | Z-1 | Z-1 | Z-1 | Z- | Z-1 | Z-1 | Z-1 |
| Lightness L*45 | 80 | 80 | 80 | 78 | 82 | 79 | 81 | 84 | 77 |
| 60° Specular gloss | 102 | 102 | 102 | 104 | 100 | 102 | 101 | 97 | 105 |
| Flip-flop value | 0.62 | 0.62 | 0.61 | 0.70 | 0.56 | 0.63 | 0.59 | 0.50 | 0.70 |
| Reworkability | A | A | A | B | A | B | A | A | B |

TABLE 4

| | Comparative Example | | | | | | | |
|---|---|---|---|---|---|---|---|---|
| | 1 | 2 | 3 | 4 | 5 | 6 | 7 | 8 |
| Name of base | X-1 | X-1 | X-2 | X-1 | X-1 | X-1 | X-1 | X-1 |
| coating (X) | | | | | | | | |
| Film thickness | 18 | 37 | 27 | 27 | 27 | 27 | 27 | 27 |
| (μm) of base | | | | | | | | |
| coating film | | | | | | | | |
| Lightness | 90 | 90 | 80 | 90 | 90 | 90 | 90 | 90 |
| L*45 of base | | | | | | | | |
| coating film | | | | | | | | |
| Name of glitter | Y-1 | Y-1 | Y-1 | Y-6 | Y-7 | Y-8 | Y-9 | Y-1 |
| pigment | | | | | | | | |
| dispersion (Y) | | | | | | | | |
| Film thickness | 0.5 | 0.5 | 0.5 | 0.5 | 0.5 | 0.5 | 0.5 | 1.5 |
| (μm) of glitter | | | | | | | | |
| coating film | | | | | | | | |
| Name of clear | Z-1 | Z-1 | Z-1 | Z-1 | Z-1 | Z-1 | Z-1 | Z-1 |
| coating (Z) | | | | | | | | |
| Lightness L*45 | 74 | 83 | 74 | 76 | 85 | 77 | 84 | 74 |
| 60° Specular | 100 | 94 | 98 | 105 | 95 | 105 | 97 | 110 |
| gloss | | | | | | | | |
| Flip-flop value | 0.50 | 0.40 | 0.43 | 0.80 | 0.40 | 0.67 | 0.43 | 1.0 |
| Reworkability | B | B | B | C | A | C | A | C |

From the above results, according to the production methods of Examples 1 to 9, good results were obtained in terms of the lightness, the 60° specular gloss, the flip-flop value, and the reworkability, and therefore a multilayer coating film having a high gloss at a highlight, a high lightness throughout the film from the highlight to a shade, and an excellent reworkability could be formed. In addition, since the multilayer coating film had a high lightness and high 60° specular gloss, a white metallic multilayer coating film was formed.

In the production method of Comparative Example 1 in which the film thickness of the base coating film was small, the lightness of the multilayer coating film was reduced.

In the production method of Comparative Example 2 in which the film thickness of the base coating film was large, the 60° specular gloss and the flip-flop value of the multilayer coating film were reduced.

In the production method of Comparative Example 3 in which the lightness of the base coating film was low, the lightness and the flip-flop value of the multilayer coating film were reduced.

In the production method of Comparative Example 4 in which a blending ratio of the aluminum flake pigment (A) and the titanium oxide (B) in the glitter pigment dispersion (Y) was greater than a specific range, the flip-flop value of the multilayer coating film was excessive and the reworkability was reduced.

In the production method of Comparative Example 5 in which the blending ratio of the aluminum flake pigment (A) and the titanium oxide (B) in the glitter pigment dispersion (Y) was smaller than the specific range, the flip-flop value of the multilayer coating film was reduced.

In the production method of Comparative Example 6 in which a blending amount of the titanium oxide (B) in the glitter pigment dispersion (Y) was greater than a specific range, the reworkability of the multilayer coating film was reduced.

In the production method of Comparative Example 7 in which the blending amount of the titanium oxide (B) in the glitter pigment dispersion (Y) was smaller than a specific range, the flip-flop value of the multilayer coating film was reduced.

In the production method of Comparative Example 8 in which the film thickness of the glitter coating film was large, in the multilayer coating film, the lightness was low, the 60° specular gloss and the flip-flop value were excessive, and the reworkability was reduced.

Although the embodiments and examples of the present invention have been specifically described above, the present invention is not limited to the embodiments described above, and various modifications based on the technical concept of the present invention are possible.

For example, the configurations, methods, steps, shapes, materials, and values listed in the embodiments and examples described above are merely examples, and configurations, methods, steps, shapes, materials, and values different from these may be used, if necessary.

In addition, the configurations, methods, steps, shapes, materials, and values of the embodiments described above can be combined with each other within a scope that does not deviate from the gist of the present invention.

The present application is based on Japanese Patent Application No. 2022-079518 filed on May 13, 2022, the contents of which are incorporated herein by reference.

1. A method for producing a multilayer coating film, the method comprising the following steps (1) to (4):
a step (1) of applying a base coating (X) directly on an electrodeposition coating film to form a base coating film having a dry film thickness of 20 μm to 35 μm and a lightness L*45 of 85 to 95;
a step (2) of applying a glitter pigment dispersion (Y) on or above the base coating film formed in the step (1) to form a glitter coating film having a dry film thickness of 0.01 μm to 1.0 μm;
a step (3) of applying a two-component clear coating (Z) comprising a hydroxy group-containing acrylic resin and a polyisocyanate compound on or above the glitter coating film formed in the step (2) to form a clear coating film; and
a step (4) of heating the uncured base coating film, the uncured glitter coating film, and the uncured clear coating film formed in the steps (1) to (3), respectively, to simultaneously cure these three coating films, wherein
the glitter pigment dispersion (Y) comprises an aluminum flake pigment (A), titanium oxide (B), a hydroxy group-containing acrylic resin (C), a viscosity modifier (D), and water,
a content of the titanium oxide (B) is 10 mass % to 20 mass % of a total solid content of the glitter pigment dispersion (Y),
a blending ratio of the aluminum flake pigment (A) to the titanium oxide (B) is 0.8 to 1.2 in terms of a mass ratio of the aluminum flake pigment (A)/the titanium oxide (B), and
in the multilayer coating film, a lightness L*45 is within a range of 75 to 85, a 60-degree specular gloss is within a range of 95 to 105, and a flip-flop value is within a range of 0.5 to 0.7.

2. A multilayer coating film comprising:
an electrodeposition coating film;
a base coating film;
a glitter coating film; and
a clear coating film in this order, wherein
the base coating film has a film thickness of 20 μm to 35 μm and a lightness L*45 of 85 to 95,
the glitter coating film comprises an aluminum flake pigment (A) and titanium oxide (B), and has a film thickness of 0.01 μm to 1.0 μm,
a content of the titanium oxide (B) in the glitter coating film is 10 mass % to 20 mass %, and a mass ratio of the aluminum flake pigment (A)/the titanium oxide (B) is 0.8 to 1.2,
the clear coating film comprises a cured product of a hydroxy group-containing acrylic resin and a polyisocyanate compound, and
in the multilayer coating film, a lightness L*45 is within a range of 75 to 85, a 60-degree specular gloss is within a range of 95 to 105, and a flip-flop value is within a range of 0.5 to 0.7.
